(19) United States
(12) Patent Application Publication
(10) Pub. No.: US 2017/0249314 A1
(43) Pub. Date: Aug. 31, 2017

(54) APPARATUS AND METHOD TO DETERMINE A PREDICTED-RELIABILITY OF SEARCHING FOR AN ANSWER TO QUESTION INFORMATION

(71) Applicant: FUJITSU LIMITED, Kawasaki-shi (JP)

(72) Inventors: Miho Sakai, Yokohama (JP); Ryuichi Takagi, Nakano (JP); Hiroshi Kogota, Yokohama (JP); Jianping Li, Yokohama (JP); Masaya Yamada, Yokohama (JP)

(73) Assignee: FUJITSU LIMITED, Kawasaki-shi (JP)

(21) Appl. No.: 15/426,213

(22) Filed: Feb. 7, 2017

(30) Foreign Application Priority Data
Feb. 26, 2016 (JP) 2016-035461

(51) Int. Cl. G06F 17/30

(52) U.S. Cl. CPC G06F 17/3053; G06F 17/3043

(57) ABSTRACT

An apparatus stores teacher data including first question-information and first answer-information associated therewitg, and supplementary information each piece of which is associated With one or more keywords that are used within the teacher data in connection therewith. The apparatus extracts first keywords tom the teacher data, and adjust parameter-values which are used for calculating a predicted-reliability of each piece of the first answer-information and each associated with one of pieces of the supplementary information, based on the supplementary information associated with the first keywords, and right/wrong in:formation indicating whether the first answer-information is a right answer. When outputting pieces of second answer-information in response to new question-information, the apparatus calculates the predicted-reliability of each piece of die second answer-information, based on the adjusted parameter-values, by using the supplementary information associated with keywords that are extracted from the new question-information and the each piece of the second answer-information.

### CROSS-REFERENCE TO RELATED APPLICATION

This application is based upon and claims the benefit of priority of the prior Japanese Patent Application No. 2016-035461, filed on Feb. 26, 2016, the entire contents of which are incorporated herein by reference.

### FIELD

The embodiments discussed herein are related to apparatus and method to determine a predicted reliability of searching for an answer to question information.

### BACKGROUND

Providers who provide service to users (hereinafter also simply referred to as providers) build and operate business systems (hereinafter, also referred to as, information processing systems) suitable for usage purposes in order to provide various kinds of services to the users, for example. When an information processing system receives a question text (hereinafter, also referred to as question information) on the service from a user, for example, the information processing system searches a storage unit in which answer texts to question texts (hereinafter, also referred to as answer information) are stored to find an answer text to the received question text. The information processing system then transmits the searched-out answer text to the user,

When searching for an answer text as described above, the information processing system segments the received question text into morphs to generate a keyword group including multiple keywords, for example. The information processing system then extracts an answer text that includes a large number of keywords among the keywords in the generated keyword group, from the multiple answer texts stored in the storage unit, for example. This enables the provider to transmit to the user the answer text to the question text received from the user (for example, refer to Japanese Laid-open Patent Publication Nos. 2002-334107, 09-81578, 2003-91556, and 2007-102723).

### SUMMARY

According to an aspect of the invention, an apparatus stores teacher data and supplementary information, where the teacher data includes first question information and first answer information, each piece of the first question information indicates a question about a predetermined subject, each piece of the first answer information is associated with a piece of the first question information and indicates an answer that is responsive to the piece of the first question information, and each piece of the supplementary information is associated with one or more keywords that are used within the first question information or the first answer information in connection with the each piece of supplementary information. The apparatus extracts first keywords from the teacher data, and adjusts a calculation parameter including parameter-values that are each associated with one of pieces of the supplementary information and used for calculating a predicted-reliability, based on the supplementary information associates with the first keywords, and right/wrong information indicating whether each piece of the first answer information is a right answer to a piece of the first question information associated with the each piece of the fast answer information, where the predicted-reliability indicates a likelihood that each piece of the first answer information is an answer that is responsive to a piece of the first question information associated with the each piece of the first answer information. When outputting plural pieces of second answer information in response to new question information, the apparatus calculates the predicted-reliability of each piece of the second answer information, based on the adjusted calculation parameter, by using the supplementary information associated with second keywords that are extracted from the new question information and the each piece of the second answer information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing system, according to an embodiment;

FIG. 2 is a diagram illustrating an example of a search for answer information, according to an embodiment;

FIG. 3 is a diagram illustrating an example of a search for answer information, according to an embodiment;

FIG. 4 is a diagram illustrating an example of a hardware configuration of an information processing device, according to an embodiment;

FIG. 5 is a diagram illustrating an example of a functional configuration of an information processing device, according to an embodiment;

FIG. 6 is a diagram illustrating an example of an operational flowchart for an outline of search control processing, according to an embodiment;

FIG. 7 is a diagram illustrating an example of an operational flowchart for an outline of search control processing, according to an embodiment;

FIG. 8 is a diagram illustrating an example of an outline of search control processing, according to an embodiment;

FIG. 9 is a diagram illustrating an example of an outline of search control processing, according to an embodiment;

FIG. 10 is a diagram illustrating an example of an operational flowchart for a detail of search control processing, according to an embodiment;

FIG. 11 is a diagram illustrating an example of an operational flowchart for a detail of search control processing, according to an embodiment;

FIG. 12 is a diagram illustrating an example of an operational flowchart for a detail of search control processing, according to an embodiment;

FIG. 13 is a diagram illustrating an example of teacher data, according to an embodiment;

FIG. 14 is a diagram illustrating an example of keyword information extracted from first question information and first answer information, according to an embodiment;

FIG 15 is a diagram illustrating an example of a viewpoint table, according to an embodiment;

FIG. 16 is a diagram illustrating an example of supplementary information specified in the processing at S24, according to an embodiment;

FIG. 17 is a diagram illustrating an example of supplementary information specified in the processing at S25, according to an embodiment;

FIG. 18 is a diagram illustrating an example of first supplementary information specified in the processing at S26, according to an embodiment;

FIG. 19 is a diagram illustrating an example of first supplementary information specified in the processing at S26, according to an embodiment;

FIG. 20 is a diagram illustrating an example of second question information, according to an embodiment;

FIG. 21 is a diagram illustrating an example of second answer information, according to an embodiment;

FIG. 22 is a diagram illustrating an example of second supplementary information specified in the processing at S37, according to an embodiment;

FIG. 23 is a diagram illustrating an example of a calculation parameter, according to an embodiment;

FIG. 24 is a diagram illustrating an example of priority information, according to an embodiment;

FIG. 25 is a diagram illustrating an example of first supplementary information when a search score is set, according to an embodiment; and

FIG. 26 is a diagram illustrating an example of priority information, according to an embodiment.

### DESCRIPTION OF EMBODIMENTS

When searching out an answer text to the question text received from the user, the information processing system as described above outputs the searched-out answer text to an output device viewable by the user, for example. Then, when searching out multiple answer texts, the information processing system preferentially outputs the answer texts determined to be more appropriate, for example.

However, the answer text that the user seeks for does not match the answer text that the information processing system determines to be more appropriate for the question text, in some cases. Moreover, the user may read only the most-preferentially outputted answer text (for example, the answer text outputted at a position most-easily viewed by the user in the output device) among the answer texts outputted to the output device, in some cases. Accordingly, the information processing system may fail to allow the user to read the answer text that the user seeks for, in some cases.

It is preferable to appropriately determine the priority for outputting searched-out results.

[Configuration of Management Device and Physical Machine]

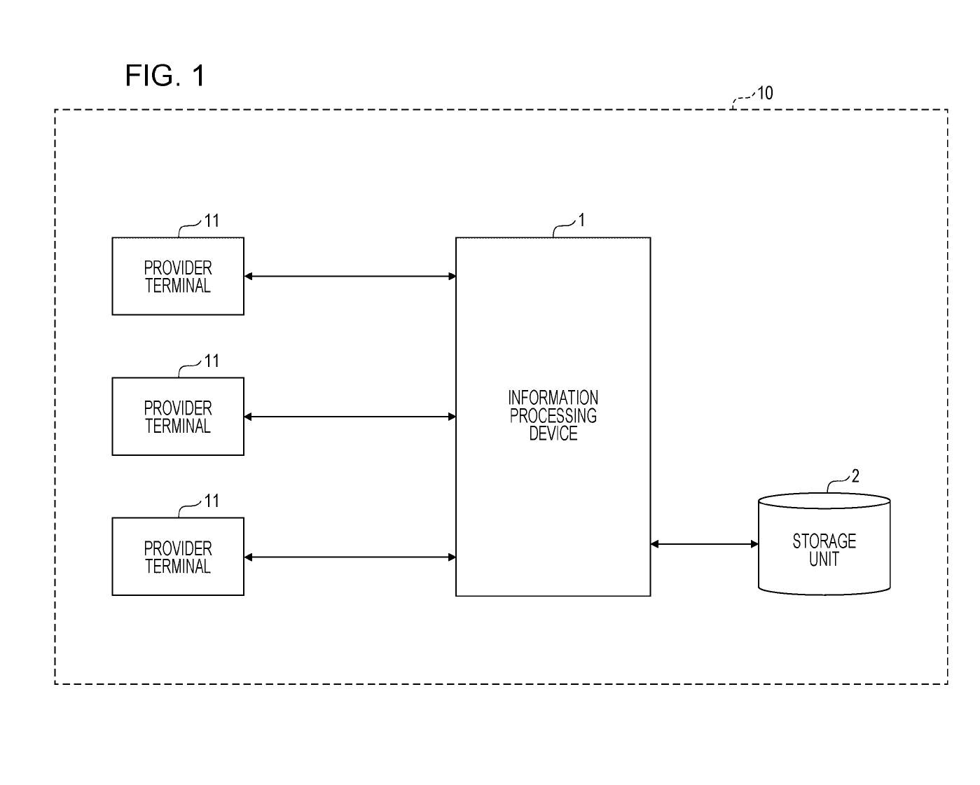

FIG. 1 is a diagram illustrating a configuration of an information processing system 10. The information processing system 10 illustrated in FIG. 1 includes an information processing device 1 (hereinafter, also referred to as search control device 1), a storage unit 2, and multiple provider terminals 11, for example.

When the information processing device 1 receives question information transmitted from the provider terminal 11 that is a terminal used by a provider, the information processing device 1 searches for answer information to the received question information (answer information that includes information for solving a question included in the received question information). The information processing device 1 then transmits the searched-out answer information to the provider terminal 11.

The provider terminals 11 are terminals used by the providers, and each transmit question information to the information processing device 1, for example. Specifically, for example, the provider terminal 11 extracts a part of the content described in an e-mail (for example, e-mail in which a content of inquiry related to a service is described) that is transmitted from a user, and transmits the extracted part of the content as question information to the information processing device 1. Moreover, the provider terminal 11 transmits a content (for example, inquiry content related to a service) inputted by a person in charge who was contacted by phone from a user as question information, to the information processing device 1, for example.

[Search for Answer Information]

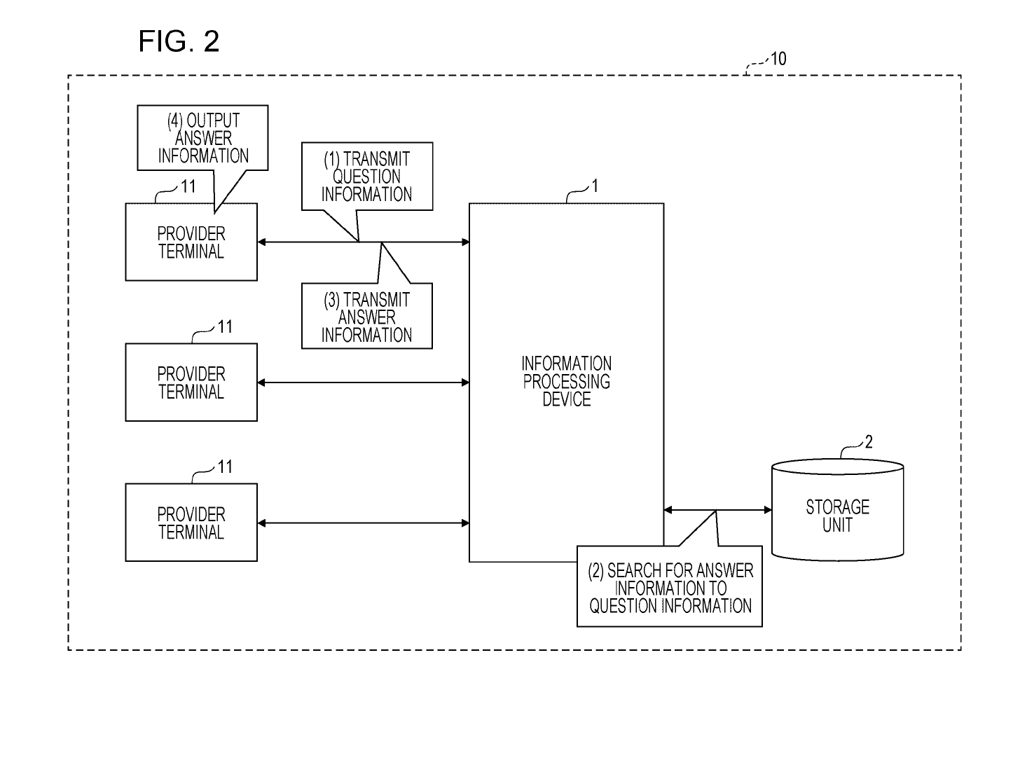

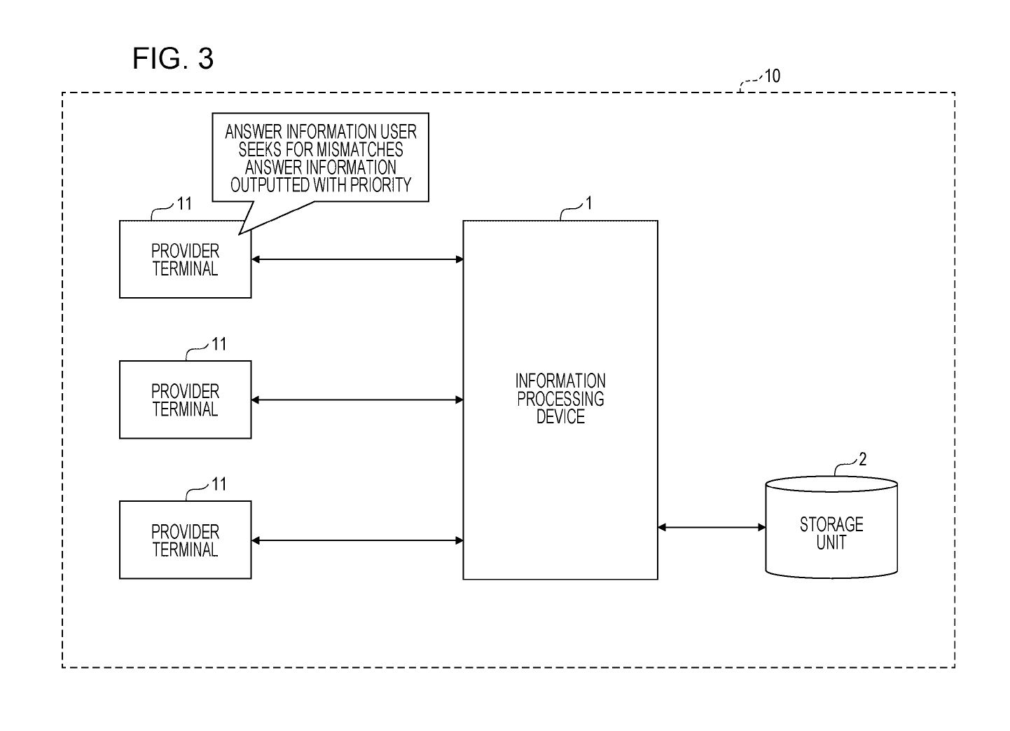

Next, a search for answer information will be described. FIGS. 2 and 3 are diagrams explaining a search for answer information.

As illustrated in FIG. 2, for example, when the provider terminal 11 receives an e-mail transmitted by a user or when a person in charge who was contacted by phone from a user inputs a content of the contact by phone, the provider terminal 11 transmits question information to the information processing device 1 ((1) of FIG. 2).

When the information processing device 1 receives the question information transmitted by the provider terminal 11, the information processing device 1 then searches for answer information to the received question information ((2) of FIG. 2). Specifically, when the information processing device 1 receives question information from the provider terminal 11, the information processing device 1 segments the received question information into morphs to generate a keyword group including multiple keywords, for example. The information processing device 1 then accesses the storage unit 2 that stores therein pieces of answer information to pieces of question information, and extracts a piece(s) of answer information that includes a larger number(s) of keywords among the keywords included in the generated keyword group, for example.

Thereafter, the information processing device 1 transmits the searched-out answer information to the provider terminal 11 ((3) of FIG. 2). The provider terminal 11 then outputs the answer information transmitted from the information processing device 1 to an output device (not illustrated) viewable by the user ((4) of FIG. 2), for example. This enables the user to read the answer information to the content of inquiry having been transmitted or the like.

Here, when multiple searched-out pieces of answer information are present, for example, the information processing device 1 causes the provider terminal 11 to more preferentially output answer information determined to be more appropriate by the information processing device 1. However, as illustrated in FIG. 3, the answer information that the user seeks for does not match the answer information determined to be more appropriate by the information processing device 1, in some cases. Moreover, the user reads only the piece of answer information outputted with priority among the pieces of the answer information outputted, to the provider terminal 11, in some cases. Accordingly, the information processing device 1 may fail to allow the user to read the answer information that the user seeks for, in some cases.

To address this, the information processing device 1 in this embodiment extracts keywords from question information (hereinafter, also referred to as first question information) and answer information (hereinafter, also referred to as first answer information), which are included in teacher data. The information processing device 1 then executes machine learning on a calculation parameter including parameter-values used for calculating a predicted reliability of the first answer information, which indicates how much the first answer information is likely to be an answer that is responsive to the first question information. For example, the information processing device 1 executes machine learning, based on supplementary information associated with keywords extracted from first question information, supplementary information associated with keywords extracted from the first answer information, and right/wrong information indicating whether the first answer information is a right answer to the first question information. Further, the supplementary information is information identifying a group of keywords having meanings falling under the same concept, in other words, is information on a higher-level concept of the keywords.

Thereafter, when the information processing device 1 outputs multiple pieces of answer information (hereinafter, also referred to as second answer information) to inputted new question information (hereinafter, also referred to as second question information), the information processing device 1 calculates the predicted-reliability of each of the multiple pieces of second answer information. Specifically, the information processing device 1 calculates the predicted-reliability of each of the multiple pieces of the second answer information with a calculation parameter obtained through the machine learning, based on supplementary information associated with keywords extracted from the second question information, and supplementary information associated with keywords extracted from the piece of the second answer information.

In other words, for example, the provider selects in advance question information to be highly likely received from the provider terminal 11 as first question information. Moreover, when a search with'the selected first question information is performed, the provider selects answer information to be desirably searched out as first answer information. In addition, for example, the provider creates teacher data in which the selected first question information and the selected first answer information, and right/wrong information indicating that the selected first answer information is an appropriate answer (right answer) to the first question information are associated with each other. Moreover, when a search with the selected first question information is performed, the provider selects answer information to be desirably searched out as different first answer information. Further, for example, the provider creates teacher data in which the selected first question information and the different first answer information, and right/wrong information indicating that the selected different first answer information is not an appropriate answer (wrong answer) to the first question information are associated with each other. Thereafter, the information processing device 1 executes machine learning by associating the first question information, the first answer information, and the right/wrong information, which are included in the teacher data with each other.

This allows the information processing device 1 to execute machine learning for first question information while distinguishing first answer information that the user seeks for from first answer information (different first answer information) that the user does not seek for.

Meanwhile, when the information processing device 1 outputs multiple pieces of second answer information that are results of the search with the inputted second question information, the information processing device 1 refers to a calculation parameter obtained through the machine learning with the, teacher data that is created by the provider. The information processing device 1 then calculates the predicted-reliability of each of the multiple pieces of second answer information to be outputted such that the piece of the second answer information that the user further seeks for has a high predicted-reliability, for example.

This enables the information processing device 1 to output second answer information in descending order of the calculated predicted-reliability (hereinafter, also referred to as priority), for example. Accordingly, the information processing device 1 enables the user to preferentially read answer information that the user seeks for. In other words, the result of evaluation of each piece of the second answer information allows the information processing device 1 to perform priority control for more preferentially presenting more likely pieces of the second answer information as answer information that the user seeks for.

[Hardware Configuration of Information Processing Device]

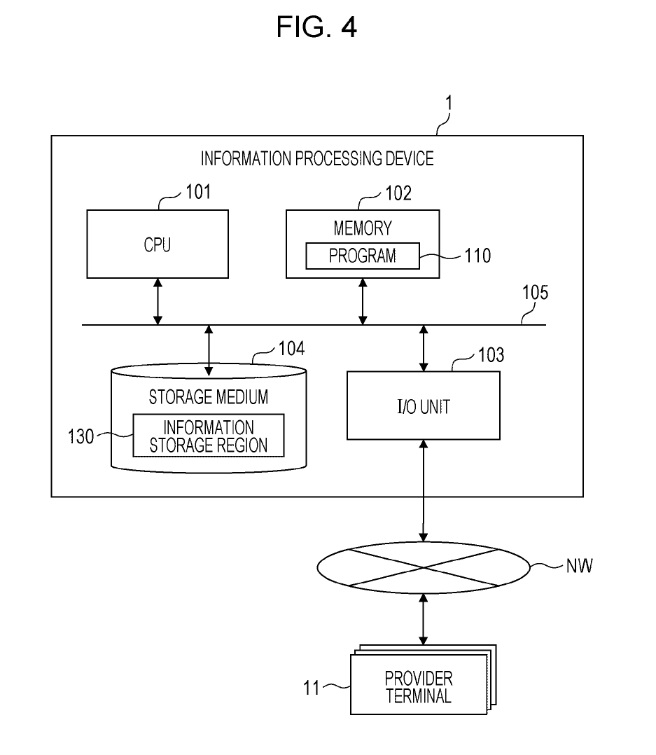

Next, a hardware configuration of the information processing device 1 will be described. FIG. 4 is a diagram illustrating the hardware configuration of the information processing device 1.

The information processing device 1 includes a CPU 101 that is a processor, a memory 102, an external interface (I/O unit) 103, and a storage medium 104. The respective units are connected to one another via a bus 105.

The storage medium 104 stores a program 110 for performing processing (hereinafter, also referred to as search control processing) of calculating the priority when the first answer information is outputted, in a program storage region (not illustrated) in the storage medium 104, for example. Moreover, the storage medium 104 includes an information storage region 130 (hereinafter, also referred to as storage unit 130) in which information used when the search control processing is performed is stored, for example.

As illustrated in FIG. 4, when the program 110 is executed, the CPU 101 loads the program 110 from the storage medium 104 into the memory 102, and performs the search control processing together with the program 110. Moreover, the external interface 103 communicates with the provider terminals 11 via a network NW including an intranet, the Internet, and others, for example.

[Function of Information Processing Device]

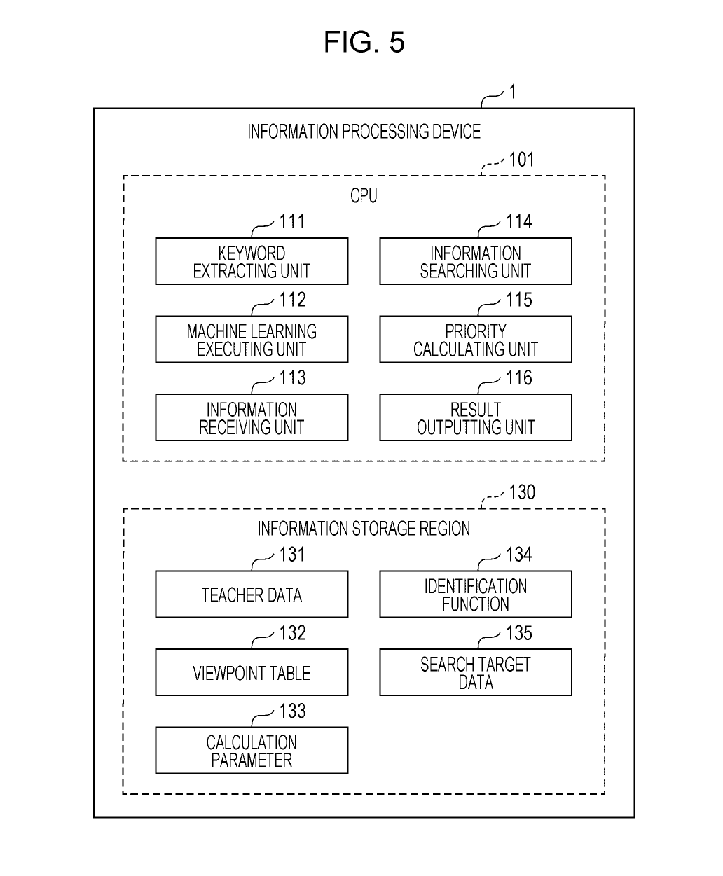

Next, a function of the information processing device 1 will be described. FIG. 5 is a function block diagram of the information processing device 1.

The CPU 101 of the information processing device 1 cooperates with the program 110 to operate as a keyword extracting unit 111 (hereinafter, also referred to as extracting unit 111 or receiving unit 111), a machine learning executing unit 112, an information receiving unit 113, and an information searching unit 114, for example. Moreover, the CPU 101 of the information processing device 1 cooperates with the program 110 to operate as a priority calculating unit 115 (hereinafter, also simply referred to as calculating unit 115), and a result outputting unit 116, for exampled. In addition, for example, teacher data 131, a viewpoint table 132, a calculation parameter 133, an identification function 134, and search target data 135 are stored in the information storage region 130. Note that, an explanation is hereinafter made by assuming that the teacher data 131 includes first question information 131a, first answer information 131b, and right/wrong information 131c which are associated with each other.

The keyword extracting unit 111 extracts keywords from the first question information 131a and the first answer information 131b which are included in the teacher data 131 stored in the information storage region 130. For example, the keyword extracting unit 111 extracts keywords by performing morpheme segmentation on the first question information 131a and the first answer information 131b.

Moreover, when the information searching unit 114 searches for second answer information 141b with keywords extracted from second question information 141a, the keyword extracting unit 111 extracts keywords from each of the second question information 141a and the second answer information 141b. For example, the keyword extracting unit 111 extracts keywords by performing morpheme segmentation on the second question information 141a and the second answer information 141b.

For example, the teacher data 131 includes information in which first question information 131a that the information processing device 1 highly likely receives, first answer information 131b that is an answer that the user seeks for, and the right/wrong information 131c indicating that the first answer information 131b is an appropriate answer to the first question information 131a are associated with each other. Moreover, for example, the teacher data 131 includes information in which the first question information 131a that the information processing device 1 highly likely receives, different first answer information 131b that is not an answer that the user seeks for, and the right/wrong information 131c indicating that the different first answer information 131b is not an appropriate answer to the first question information 131a are associated with each other.

This enables the information processing device 1 to execute machine learning for first question information while distinguishing first answer information that the user seeks for from first answer information (different first answer information) that the user does not seek for, as described later. A specific example of the teacher data 131 will be described later.

Meanwhile, the keyword extracting unit 111 may he configured to receive the input of the teacher data 131 when the provider or the like inputs the teacher data 131 to the information processing device 1.

The machine learning executing unit 112 executes machine learning on the calculation parameter 133 including parameter-values used for calculating a predicted-reliability of the first answer information 131b included in the teacher data 131, where the predicted-reliability indicates how much the first answer information 131b is likely to be an answer to the first question information 131a.

For example, the machine learning executing unit 112 specifies supplementary information (hereinafter, also referred to as first supplementary information, first correlation information, or first correlation degree) that is included in supplementary information associated with keywords extracted from the first question information 131a, and in supplementary information associated with keywords extracted from the first answer information 131b. The machine learning executing unit 112 then inputs the first supplementary information and the priority of the first answer information 131b, as learning data, to the identification function 134 so as to adjust the parameter-values included in the calculation parameter 133. The identification function 134 is a function for outputting a predicted-reliability of the first answer information 131b, its other words, a function for outputting priority of the first answer information 131b, when the first supplementary information and the calculation parameter 133 at inputted, for example. Further, when the right/wrong information 131c associated with the first answer information 131b indicates that the first answer information is an appropriate answer, the machine learning executing unit 112 may input, as learning data, “1.0” as the priority of the first answer information 131b to the identification function 134, for example. Meanwhile, when the right/wrong information 131c associated with the first answer information 131b indicates that the first answer information is an inappropriate answer, the machine learning executing unit 112 may input, as learning data, “0.0” as the priority of the fast answer information 131b to the identification function 134, for example. Further, the machine learning, executing unit 114 executes machine learning on the calculation parameter 133 for each piece of first supplementary information, for example.

In other words, every time learning data is inputted to the identification function 134, the machine learning executing unit 112 adjusts the calculation parameter 133 so that the identification function 134 is established not only for learning data inputted in the past but also for learning data newly inputted. This enables the machine learning executing unit 112 to improve the accuracy of the calculation parameter 133 every time learning data is inputted into the identification function 134. Accordingly, even when first supplementary information that is not subjected to machine learning is inputted, the priority calculating unit 115 is capable of predicting and outputting the priority of the lint answer information 131b associated with the inputted first supplementary information with the generalization function of the machine learning, as described later.

Note that, the machine learning executing unit 112 may operate in accordance with an algorithm, such as adaptive regularization of weight vectors (AROW), confidence weighted (CW), or sou confidence weighted learning (SCW).

The information receiving unit 113 receives new question information (hereinafter, also referred to as second question information 141a) transmitted by the provider terminal 11.

The information searching unit 114 searches for answer information (hereinafter, also referred to as second answer information 141b) to the second question information 141a by using keywords extracted by the keyword extracting unit 111. For example, the information searching unit 114 searches the search target data 135 including multiple pieces of answer information prepared in advance by the provider, for the second answer information 141b. The search target data 135 may include answer information the same as the first answer information 131b included in the teacher data 131. Further, the provider may utilize a search engine for open source as the information searching unit 114, for example.

Before multiple pieces of the second answer information 141b searched out by the information searching unit 114 with the second question information 141a are outputted, the priority calculating unit 115 calculates the priority of each of the multiple pieces of the second answer information 141b by using the calculation parameter 133 stored in the information storage region 130. For example, the priority calculating unit 115 specifies, for each of the multiple pieces of the second answer information 141b, supplementary information (hereinafter, also referred to as second supplementary information, second correlation information, or second correlation degree) that is included in supplementary information associated with keywords extracted from the second question information 141a, and also included in supplementary information associated with keywords extracted from the each piece of the second answer information 141b. The priority calculating unit 115 inputs the second supplementary information and the calculation parameter 133 to the identification function 134, and acquires the priority outputted as the priority of the second answer information 141b.

The result outputting unit 116 transmits the multiple pieces of the second answer information 141b searched out by the information searching unit 114 to the provider terminal 11. The provider terminal 11 then outputs the received multiple pieces of the second answer information 141b in descending order of the priorities (predicted-reliabilities) calculated by the priority calculating unit 115 to an output device (output device viewable by the user), for example. Note that, the viewpoint table 132 will be described later.

### First Embodiment

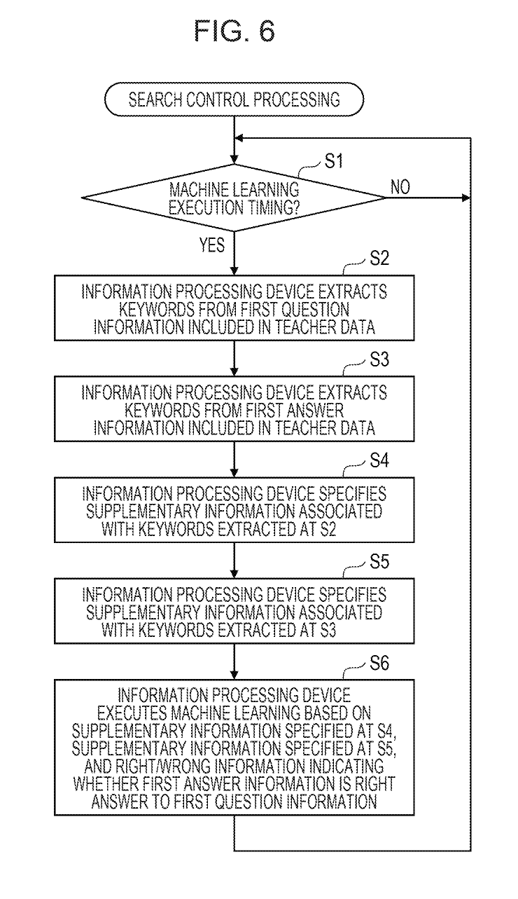

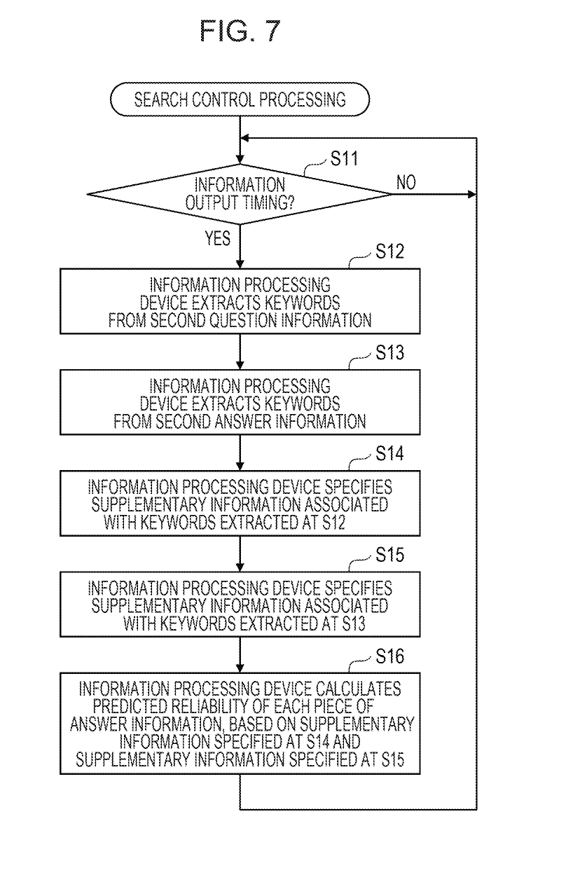

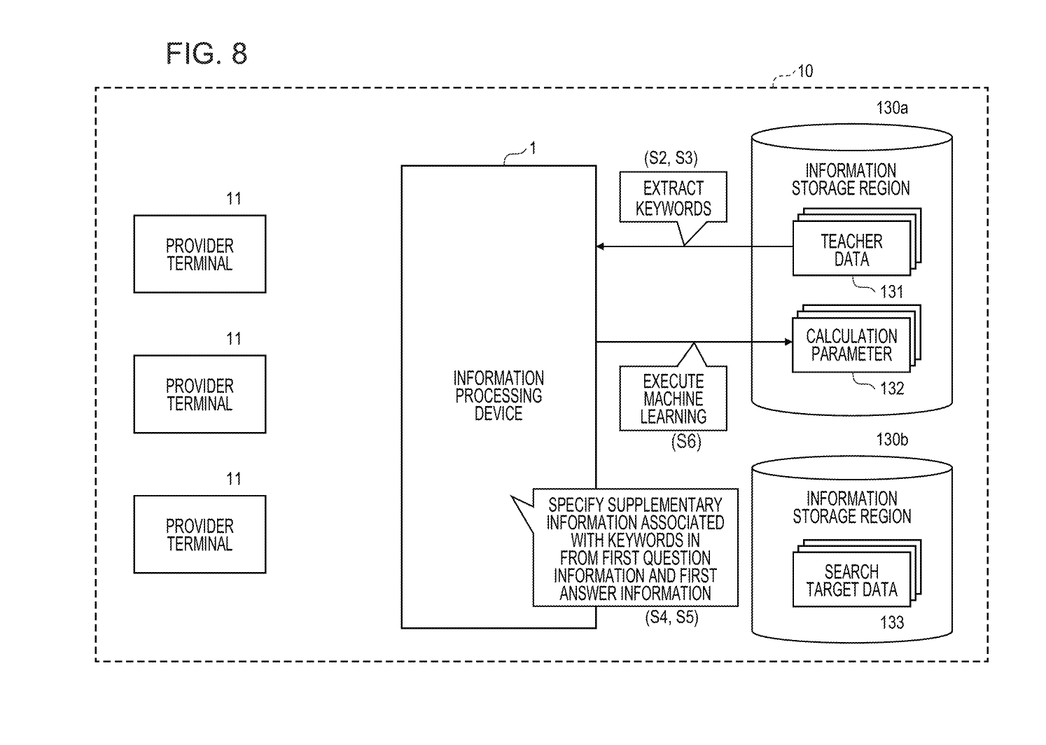

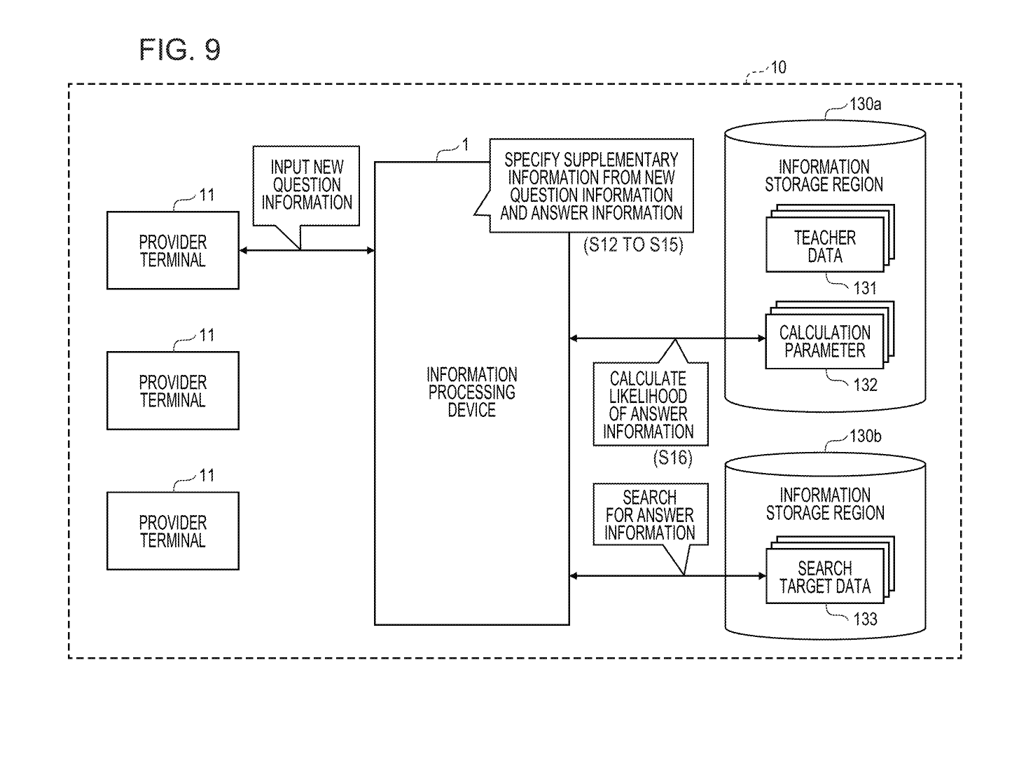

Next, a first embodiment will be described. FIGS. 6 and 7 are operational flowcharts explaining an outline of search control processing in the first embodiment. Moreover, FIGS. 8 and 9 are diagrams explaining the outline of the search control processing in the first embodiment. With reference to FIGS. 8 and 9, the search control processing of FIGS. 6 and 7 will be schematically described.

The information processing device 1 waits until machine learning execution timing comes (NO at S1). The machine learning execution timing is timing when the provider executes machine learning of the teacher data 131, for example. Specifically, the machine learning execution timing may be timing when the provider performs an input indicating that machine learning of the teacher data 131 is executed, for example.

When the, machine learning execution timing comes (YES at S1), as illustrated in FIG. 8, the information processing device 1 extracts keywords from the first question information 131a included in the teacher data 131 (S2). Further, the information processing device 1 extracts keywords from the first answer information 131b included in the teacher data 131 (S3).

The information processing device 1 then specifies supplementary information associated with the keywords that were extracted in the processing at S2 (S4). Moreover, the information processing device 1 specifies supplementary information associated with the keywords that were extracted in the processing at S3 (S5). Thereafter, the information processing device 1 executes machine learning based on the supplementary information specified in the processing at S4, the supplementary information specified in the processing at S5, and the right/wrong information 131c indicating whether the first answer information 131b is a right answer to the first question information 131a (S6). In other words, the information processing device 1 executes machine learning for the first question information 131a while distinguishing the first answer information 131b that is answer information that the user seeks for from the first answer information 131b that is answer information that the user does not seek for.

Thereafter, the information processing device 1 waits until information output timing (NO at S11). The information output timing is tuning when the information processing device 1 searches for the second answer information 141b with the second question information 141a, for example. When the information output timings comes (YES at S11), as illustrated in FIG. 9, the information processing device 1 extracts keywords from the second question information 141a (S12). In addition, the information processing device 1 extracts keywords from the second answer information 141b (S13).

The information processing device 1 then specifies supplementary information associated with the keywords that were extracted in the processing at S12 (S14). Moreover, the information processing device 1 specifies supplementary information associated with the keywords that were extracted in the processing at S13 (S15). Thereafter, the information processing device 1 calculates the predicted-reliability (priority) of answer information included in each of the multiple pieces of the second answer information 141b, based on the supplementary information specified in the processing at S14 and the supplementary information specified in the processing at S15 (S16).

In other words, when the information processing device 1 searches for the second answer information 141b, the information processing device 1 refers to the calculation parameter 133 obtained in advance through the machine learning of information on the first answer information 131b that the user seeks for to the first question information 131a, and calculates the priority with which the second answer information 141b is to be outputted. The information processing device 1 then outputs second answer information in descending order of the calculated priorities, for example. This allows the information processing device 1 to preferentially output the second answer information 141b that the user seeks for.

In this manner, the information processing device 1 in this embodiment extracts keywords from the first question information 131a and the first answer information 131b, which are included in the teacher data 131. The information processing device 1 then executes machine learning on the calculation parameter 133 for calculating the predicted-reliability of the first answer information 131b which indicates how much the first answer information 131b is likely to he an answer that is responsive to the first question information 131a. Specifically, the information processing device 1 executes machine learning based on supplementary information associated with the keywords extracted from the first question information 131a, supplementary information associated with the keywords extracted from the first answer information 131b, and the right/wrong information 131c indicating whether the first answer information 131b is a right answer to the first question information 131a.

Thereafter, when the information processing device 1 outputs multiple pieces of the second answer information 141b in response to the inputted second question information 141a, the information processing device 1 calculates the predicted-reliabilities of the multiple pieces of the second answer information 141b. For example, the information processing device 1 calculates the predicted-reliability of each of the multiple pieces of the second answer information 141b with the calculation parameter 133 obtained through the machine learning, based on supplementary information associated with the keywords extracted from the second question information 141a and supplementary information associated with the keywords extracted from the each piece of the second answer information 141b.

This allows the information processing device 1 to preferentially output the second answer information 141b that the user is highly likely to seeks for. Accordingly, the information processing device 1 allows the user to preferentially read the second answer information 141b that the user is highly likely seeks for.

### Details of First Embodiment

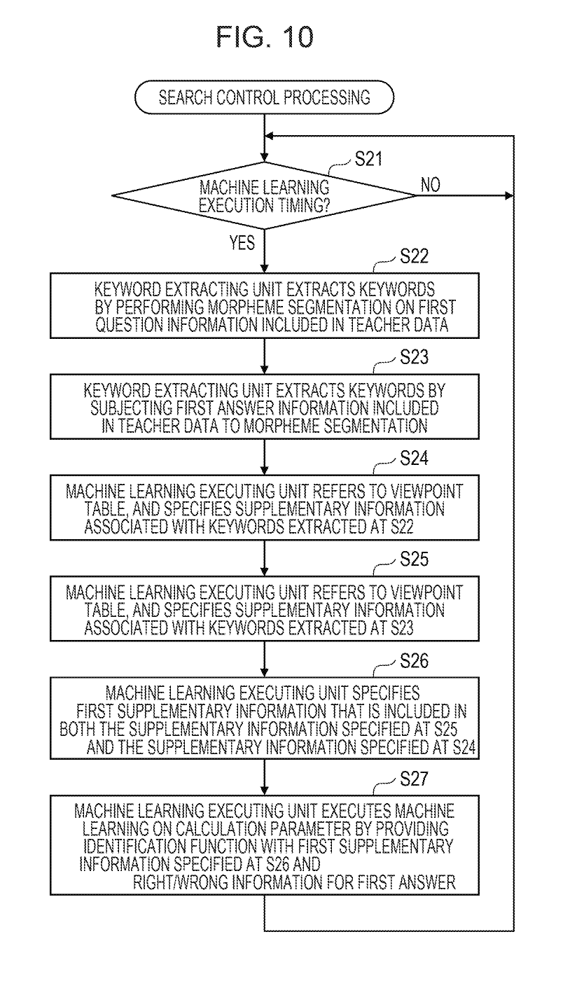

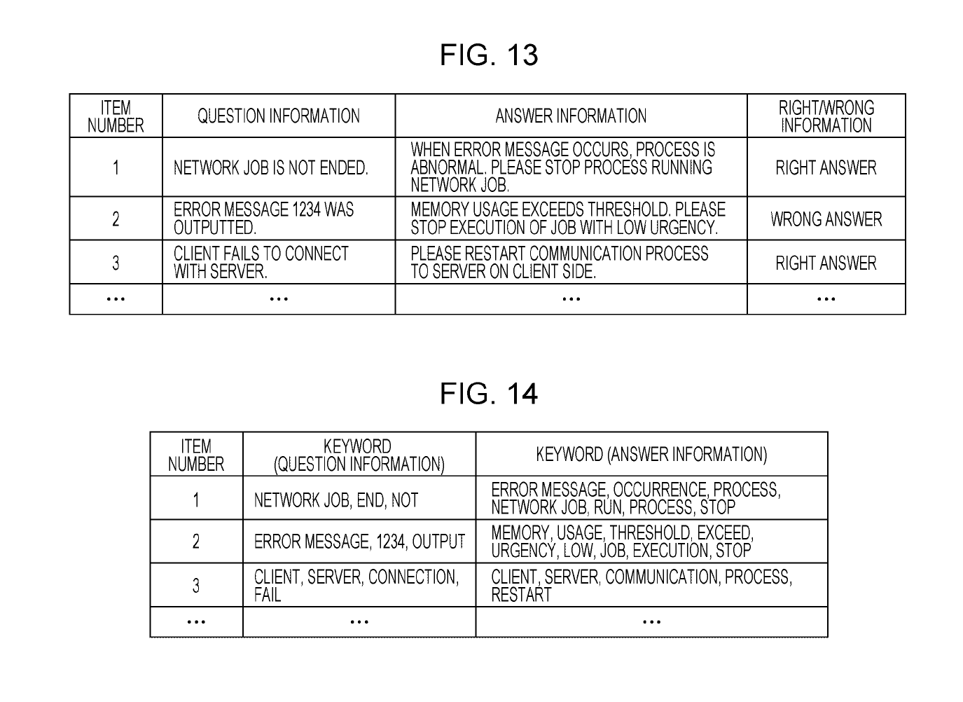

Next, the details of the first embodiment will be described. FIGS. 10 to 12 are operational flowcharts explaining the details of the search control processing in the first embodiment. Moreover, FIGS. 13 to 26 diagrams explaining the details of the search control processing in the first embodiment. With reference to from FIGS. 13 to 26, the details of the search control processing from FIGS. 10 to 12 will be described.

As illustrated in FIG. 10, the keyword extracting unit 111 of the information processing device 1 waits until the machine learning execution timing comes (NO at S21). When the machine learning execution timing comes (YES at S21), the keyword extracting unit 111 extracts keywords from the first question information 131a included in the teacher data 131 (S22). Further, in this case, the keyword extracting unit 111 extracts keywords from the first answer information 131b included in the teacher data 131 (S23). Specifically, the keyword extracting unit 111 extracts keywords by performing morpheme segmentation on the first question information 131a and the first answer information 131b. Hereinafter, a specific example of the teacher data 131 and a specific example, of the extracted keywords will be described.

[Specific Example of Teacher Data]

FIG. 13 is a diagram explaining the specific example of the teacher data 131. The teacher data 131 illustrated in FIG. 13 includes, as items, “ITEM NUMBER” that identifies each piece of information included in the teacher data 131, “QUESTION INFORMATION” to which the first question information 131a is set, and “ANSWER INFORMATION” to which the first answer information 131b is set. Moreover, the teacher data 131 illustrated in FIG. 13 includes, as an item, “RIGHT/WRONG INFORMATION” indicating whether the first answer information 131b is a right answer to the first question information 131a. As “RIGHT/WRONG INFORMATION”, set is “RIGHT ANSWER” indicating that the first answer information 131b is a right answer to the first question information 131a or “WRONG ANSWER” indicating that the first answer information 13lb is a wrong answer to the first question information 131a.

In the example illustrated in FIG. 13, a text “NETWORK JOB IS NOT FINISHED.” is set to “QUESTION INFORMATION” for a piece of information whose “ITEM NUMBER” is “1”. Moreover, in the example illustrated in FIG. 13, a text “WHEN ERROR MESSAGE OCCURS, PROCESS IS ABNORMAL, PLEASE STOP PROCESS RUNNING NETWORK JOB,” is set to “ANSWER INFORMATION” for the piece of information whose “ITEM NUMBER” is “1”. In addition, in the example illustrated in FIG. 13, “RIGHT ANSWER” is set to “RIGHT/WRONG INFORMATION” for the piece of information whose “ITEM NUMBER” is “1”.

In other words, the teacher data 131 illustrated in FIG. 13 may include multiple pieces of information in which the first question information 131a that is, expected to be transmitted from Me provider terminal 11 is associated with the first answer information 131b that is decided as a right answer to the first question information 131a by the provider, for example. Moreover, the teacher data 131 illustrated in FIG. 13 may include multiple pieces of information in which the first question information 131a that is expected to be transmitted from the provider terminal 11 is associated with the first answer information 131b that is decided as a wrong answer to the first question information 131a by the provider, for example.

This allows the information processing device 1 to execute machine learning for the first question information 131a while distinguishing the first answer information 131b that the user seeks for from the first answer information 131b that the user does not seek for, as described later. An explanation of other information included in FIG. 13 is omitted.

[Specific Example of Keywords Extracted from Question Information and Answer Information]

Next, a specific example of keywords (hereinafter, also referred to as keyword information) extracted from the first question information 131a and the first answer information 131b will be described. FIG. 14 is a diagram explaining a specific example of the keyword information extracted from the first question information 131a and the first answer information 131b.

The keyword information illustrated in FIG. 14 includes, as items, “ITEM NUMBER” that identifies each piece of information included in the keyword information illustrated in FIG. 13 and “KEYWORD (QUESTION INFORMATION)” to which keywords extracted from the first question information 131a are set. Moreover, the keyword information illustrated in FIG. 14 includes, as an item, “KEYWORD (ANSWER INFORMATION)” to which keywords extracted from the first answer information 131b are set.

For example, in the keyword information illustrated in FIG. 14, for information whose “ITEM NUMBER” is “1”, “NETWORK JOB”, “END”, and “NOT” are set as “KEYWORD (QUESTION INFORMATION)”. Moreover, in the information illustrated in FIG. 14, for information whose “ITEM NUMBER” is “1”, “ERROR MESSAGE”, “OCCURRENCE”, “PROCESS”, “NETWORK JOB”, “RUN”, “PROCESS”, and “STOP” are set as “KEYWORD (ANSWER INFORMATION)”. An explanation of other information included in FIG. 14 is omitted.

Referring back to FIG. 10, the machine learning executing unit 112 of the information processing device 1 refers to a viewpoint table 132 stored in the information storage region 130, and specifies supplementary information associated with keywords that are extracted from the first question information 131a and specified in the processing at S22 (S24). Moreover, the machine learning executing unit 112 refers to the viewpoint table 132, and specifies supplementary information associated with keywords that are extracted from the first answer information 131b and specified in the processing at S23 (S25). The viewpoint table 132 is a table in which each keyword is associated with each piece of supplementary information. The viewpoint table 132 may be stored in advance in the information storage region 130 by the provider, for example. Hereinafter, a specific example of the viewpoint table 132 and a specific example of the supplementary information will be described.

[Specific Example of Viewpoint Table]

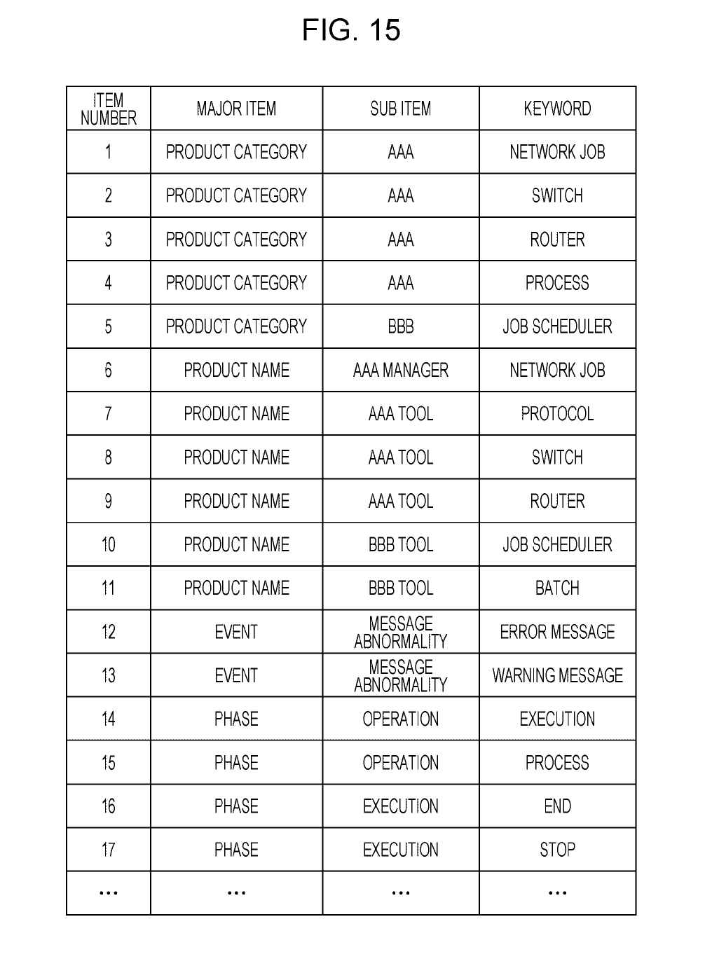

FIG. 15 is a diagram explaining a specific example of the viewpoint table 132. The viewpoint table 132 illustrated in FIG. 15 includes, as items, “ITEM NUMBER” that identifies each piece of information included in the viewpoint table 132, “MAJOR ITEM” to which a major item associated with each keyword is set, and “SUB ITEM” to which a sub item associated with each keyword is set. Moreover, the viewpoint table 132 illustrated in FIG. 15 includes, as an item, “KEYWORD” to which each keyword is set. Note that, an explanation is hereinafter made by assuming that information in which information set to “MAJOR ITEM” and information set to “SUB ITEM” are connected with “-” is a piece of supplementary information on the keyword set to “KEYWORD”.

For example, in the viewpoint table 132 illustrated in FIG. 15, for a piece of information whose “ITEM NUMBER” is “1”, “PRODUCT CATEGORY” is set as “MAJOR ITEM” and “AAA” is set as “SUB ITEM”. Further, in the viewpoint table 132 illustrated in FIG. 15, for the piece of information whose “ITEM NUMBER” is “1”, “NETWORK JOB” is set as “KEYWORD”. Moreover, in the viewpoint table 132 illustrated in FIG. 15, for a piece of information whose “ITEM NUMBER” is “12”, “EVENT” is set as “MAJOR ITEM” and “MESSAGE ABNORMALITY” is set as “SUB ITEM”. Further, in the viewpoint table 132 illustrated in FIG. 15, for the piece of information whose “ITEM NUMBER” is “12”, “ERROR MESSAGE” is set as “KEYWORD”, An explanation of other information included in FIG. 15 is omitted.

[Specific Example of Supplementary Information Specified in Processing at S24]

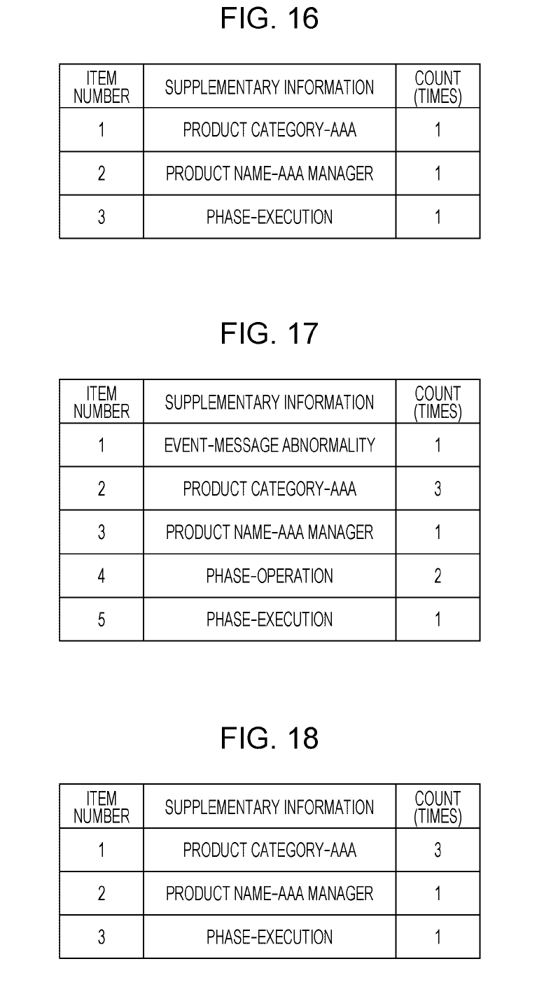

Next, a specific example of supplementary information specified in the processing at S24 will be described. FIG. 16 is a diagram explaining a specific example of supplementary information specified in the processing at S24.

The supplementary information illustrated in FIG. 16 includes, as items, “ITEM NUMBER” that identifies each piece of information included in the supplementary information, “SUPPLEMENTARY INFORMATION” to which supplementary information is set, and “COUNT” to which the number of times that the keyword associated with each piece of supplementary information appears in the first question information 131a is set.

For example, in “KEYWORD (QUESTION INFORMATION)” for a piece of information whose “ITEM NUMBER” is “1” in the keyword information illustrated in FIG. 14, “NETWORK JOB”, “END”, and “NOT” are set as keywords. In this case, for example, the machine learning executing unit 112 refers to the viewpoint table 132 illustrated in. FIG. 15, and specifies a piece of information whose “ITEM NUMBER” is “1” and a piece of information whose “ITEM NUMBER” is “6”, as information in which “NETWORK JOB” is set to “KEYWORD”. The machine learning executing unit 112 then specifies “PRODUCT CATEGORY-AAA” and “PRODUCT NAME-AAA MANAGER” that are respectively supplementary information of the piece of information whose “ITEM NUMBER” is “1” and supplementary information of the information whose “ITEM NUMBER” is “6”.

Subsequently, for example, the machine learning executing unit 112 refers to the viewpoint table 132 illustrated in FIG. 15, and specifies a piece of information whose “ITEM NUMBER” is “16” as information in which “END” is set to “KEYWORD”. The machine learning executing unit 112 then specifies “PHASE-EXECUTION” that is supplementary information of the piece of information whose “ITEM NUMBER” is “16”.

In other words, the machine teaming executing unit 112 specifies “PRODUCT CATEGORY-AAA”, “PRODUCT NAME-AAA MANAGER”, and “PHASE-EXECUTION”, as supplementary information associated with a piece of information (the first question information 131a) set to “KEYWORD (QUESTION INFORMATION)” of a piece of information whose “ITEM NUMBER” is “1” in FIG. 14.

Accordingly, as illustrated in a piece of information whose “ITEM NUMBER” is “1” in FIG. 16, the machine learning executing unit 112 sets “PRODUCT CATEGORY-AAA” to “SUPPLEMENTARY INFORMATION”, and “1 (TIME)” that is the number of times that “PRODUCT CATEGORY-AAA” is specified to “COUNT”. Moreover, as illustrated in a piece of information whose “ITEM NUMBER” is “2” in FIG. 16, the machine learning executing unit 112 sets “PRODUCT NAME-AAA MANAGER” to “SUPPLEMENTARY INFORMATION”, and “1 (TIME)” that is the number of times that “PRODUCT NAME-AAA MANAGER” is specified to “COUNT”. In addition, as illustrated in a piece of information whose “ITEM NUMBER” is “3” in FIG. 16, the machine learning executing unit 112 sets “PHASE-EXECUTION” to “SUPPLEMENTARY INFORMATION”, and “1 (TIME)” that is the number of times that “PHASE-EXECUTION” is specified to “COUNT”.

Note that, in the viewpoint table 132 illustrated in FIG. 15, no information in which “NOT” is set to “KEYWORD” is present.

Specific Example of Supplementary Information Specified in the Processing at S25]

Next, a specific, example of supplementary information specified in the processing at S25 will be described. FIG. 17 is a diagram explaining a specific example of supplementary information in the processing at S25.

The supplementary information illustrated in FIG. 17 includes, as items, “ITEM NUMBER” that identifies each piece of information included in the supplementary information, “SUPPLEMENTARY INFORMATION” in which a piece of supplementary information is set, and “COUNT” in which the number of times that the keyword associated with the piece of supplementary information appears in the first answer information 131b is set.

Specifically, “ERROR MESSAGE”. “OCCURRENCE”, “PROCESS”, “NETWORK JOB”, “RUN”, “PROCESS”, and “STOP”, as keywords, are set to “KEYWORD (ANSWER INFORMATION)” of a piece of information whose “ITEM NUMBER” is “1” in the keyword information illustrated in FIG. 14. In this case, for example, the machine learning executing unit 112 refers to the viewpoint table 132 illustrated in FIG. 15, and specifies a piece of information whose “ITEM NUMBER” is “12” as the piece of information in which “ERROR MESSAGE” is set to “KEYWORD”. The machine learning executing unit 112 then specifies “EVENT-MESSAGE ABNORMALITY” that is supplementary information of the piece of information whose “ITEM NUMBER” is “12”.

Subsequently, for example, the machine learning executing unit 112 refers to the viewpoint table 132 illustrated in FIG. 15, and specifies a piece of information whose “ITEM NUMBER” is “4” and a piece of information whose “ITEM NUMBER” is “15”, as information in which “PROCESS” is set to “KEYWORD”. The machine learning executing unit 112 then specifies “PRODUCT CATEGORY-AAA” and “PHASE-OPERATION” that are respectively supplementary information of the piece of information whose “ITEM NUMBER” is “4” and supplementary information of the piece of information whose “ITEM NUMBER” is “15”. Further, “PROCESS” appears twice in information set to “KEYWORD (ANSWER INFORMATION)” of the piece of information whose “ITEM NUMBER” is “1” in FIG. 14. Accordingly, the machine learning executing unit 112 specifies twice “PRODUCT CATEGORY-AAA” and “PHASE-OPERATION” that are supplementary information, respectively.

In addition, for example, the machine learning executing unit 112 refers to the viewpoint table 132 illustrated in FIG. 1, and specifies apiece of information whose “ITEM NUMBER” is “1” and a piece of information whose “ITEM NUMBER” is “6”, as information in which “NETWORK JOB” is set to “KEYWORD”. The machine learning executing unit 112 then specifies “PRODUCT CATEGORY-AAA” and “PRODUCT NAME-AAA MANAGER” that are respectively supplementary information of the piece of information whose “ITEM NUMBER” is “1” arid supplementary information of the piece of information 2hose “ITEM NUMBER” is “6”.

Moreover, for example, the machine learning executing unit 112 refers to the viewpoint table 132 illustrated in FIG. 15, and specifies a piece of information whose “ITEM NUMBER” is “17” as information in which “STOP” is set to “KEYWORD”. The machine learning executing unit 112 then specifies “PHASE-EXECUTION” that is supplementary information of the piece of information whose “ITEM NUMBER” is “17”.

Accordingly, as illustrated in a piece of information whose “ITEM NUMBER” is “1” FIG. 17, the machine learning executing unit 112 sets “EVENT-MESSAGE ABNORMALITY” to “SUPPLEMENTARY INFORMATION”, and “1 (TIME)” that is the number of times that “EVENT-MESSAGE ABNORMALITY” is specified to “COUNT”. Moreover, as illustrated in a piece of information whose “ITEM NUMBER” is “2” in FIG. 17, the machine learning executing unit 112 sets “PRODUCT CATEGORY-AAA” to “SUPPLEMENTARY INFORMATION”, and “3 (TIMES)” that is the number of times that “PRODUCT CATEGORY-AAA” is specified to “COUNT”. In addition, as illustrated in a piece of information whose “ITEM NUMBER” is “3” in FIG. 17, the machine learning, executing unit 112 sets “PRODUCT NAME-AAA MANAGER” to “SUPPLEMENTARY INFORMATION”, and “1 (TIME)” that is the number of times that “PRODUCT NAME-AAA MANAGER” is specified to “COUNT”.

Further, as illustrated in a piece of information whose “ITEM NUMBER” is “4” in FIG. 17, the machine learning executing unit 112 sets “PHASE-OPERATION” to “SUPPLEMENTARY INFORMATION”, and “2 (TIMES) that is the number of times that “PHASE-OPERATION” is specified to “COUNT”. Moreover, as illustrated in a piece of information whose “ITEM NUMBER” is “5” in FIG. 17, the machine learning executing unit 112 sets “PHASE-EXECUTION” to “SUPPLEMENTARY INFORMATION”, and “1 (TIME)” that is the number of times that “PHASE-EXECUTION” is specified to “COUNT”.

Note that, in the viewpoint table 132 illustrated in FIG. 15, no piece of information in which “OCCURRENCE” or “RUN” is set to “KEYWORD” is present.

Referring back to FIG. 10, the machine learning executing unit 112 specifies first supplementary information that is included the supplementary information specified in the processing at S24, and also included in the supplementary information specified in the processing at S25 (S26). Hereinafter, a specific example of the first supplementary information will be described,

[Specific Example of First Supplementary Information Specified in Processing at S26]

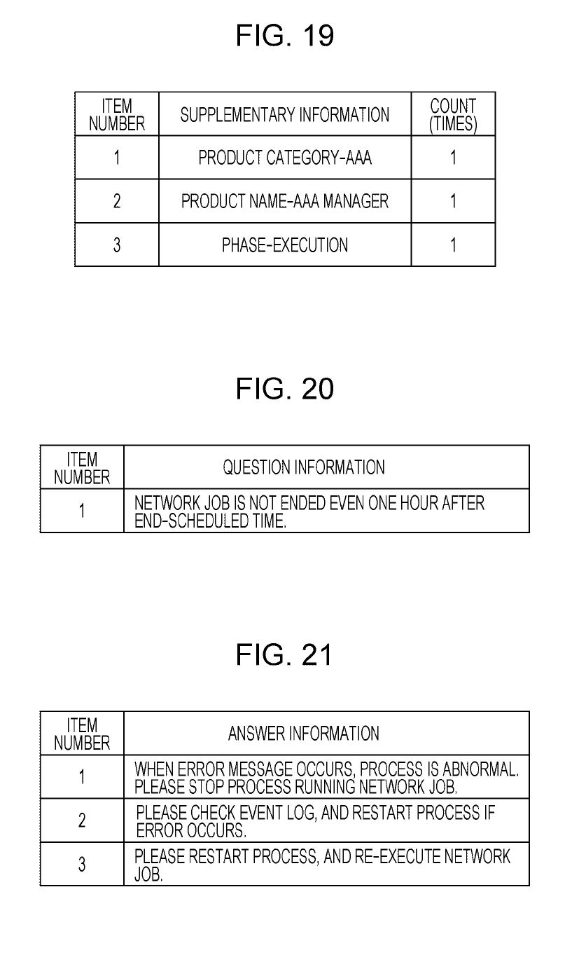

FIGS. 18 and 19 are diagrams explaining a specific example of first supplementary information specified in the processing at S26. The first supplementary information illustrated in FIGS. 18 and 19 includes the same items as those in the supplementary information explained in FIG. 16 and the like.

For example, supplementary information that is included in common in the supplementary information explained in FIG. 16 and the supplementary information explained in FIG. 17 is “PRODUCT CATEGORY-AAA”, “PRODUCT NAME-AAA MANAGER”, and “PHASE-EXECUTION”. Accordingly, as illustrated in FIG. 18, for example, the machine learning executing unit 112 sets “PRODUCT CATEGORY-AAA”, “PRODUCT NAME-AAA MANAGER”, and “PHASE-EXECUTION” to “SUPPLEMENTARY INFORMATION” of pieces of information whose “ITEM NUMBER” is “1”, “2”, and “3”.

Further, “1 (TIME)” is set to “COUNT” of a piece of information whose “SUPPLEMENTARY INFORMATION” is set at “PRODUCT CATEFORY-AAA” in FIG. 16, and “3 (TIMES)” is set to “COUNT” of a piece of information whose “SUPPLEMENTARY INFORMATION” is set at “PRODUCT CATEGORY-AAA” in FIG. 17. Accordingly, as illustrated in FIG. 18, for example, the machine learning executing unit 112 sets “3 (TIMES)”, which is a e obtained by multiplying “1 (TIME)” by “3 (TIMES)”, to “COUNT” of a piece of information whose “SUPPLEMENTARY INFORMATION” is set at “PRODUCT CATEGORY-AAA”.

Similarly, as illustrated in FIG. 18, for example, the machine learning executing unit 112 sets “1 (TIME)” to “COUNT” of a piece of information whose “SUPPLEMENTARY INFORMATION” is set at “PRODUCT NAME-AAA MANAGER”, and sets “1 (TIME)” to “COUNT” of a piece of information whose “SUPPLEMENTARY INFORMATION” is set at “PEASE-EXECUTION”.

Further, as illustrated in FIG. 19, the machine learning executing unit 112 may set “1 (TIME)” to all “COUNT” regardless of information set to “COUNT” of the supplementary information explained in FIG. 16 and the supplementary information explained in FIG. 17.

Referring back to FIG. 10, the machine learning executing unit 112 executes machine learning of the calculation parameter 133 by providing the identification function 134 with the first supplementary information specified in the processing at S26 and the right/wrong information 131c associated with the first answer information 131b, as learning data (S27).

In other words, the machine learning, executing unit 112 specifies first supplementary information by comparing the supplementary information that is a higher-level concept of keywords extracted from the first question information 131a with the supplementary information that is a higher-level concept of keywords extracted from the first answer information 131b. Therefore, for example, when multiple keywords having the similar meaning but varying in style are included in the first question information 131a, the machine learning executing unit 112 is able to perform processing by regarding these keywords as the same supplementary information. Moreover, for example, when multiple keywords having the similar meanings but varying in style are present in both the first question, information 131a and the first answer information 131b, the machine learning executing unit 112 is also able to perform processing by regarding these keywords as the same supplementary information.

This allows the machine learning executing unit 112 to exclude a slight difference in expression and the like between keywords when executing machine learning of the keywords extracted from the first question information 131a and the first answer information 131b as learning data, as described later. This allows the machine learning executing unit 112 to execute machine learning so that the contents respectively included in the first question information 131a and the first answer information 131b are reflected more accurately.

For example, the machine learning executing unit 112 specifies first supplementary information that is included in both supplementary information associated with keywords extracted from the first question in 131a in the processing at S27 and the supplementary information associated with keywords extracted from the first answer information 131b. The machine learning executing unit 112 then inputs the first supplementary Information and the priority of the first answer information 131b as learning data to the identification function 134 so as to adjust the calculation parameter 133. In the case, the machine learning executing unit 112 executes machine learning on the calculation parameter 133 for each piece of first supplementary information, for example.

In other words, the machine learning executing unit 112 adjusts the calculation parameter 133 every time learning data is inputted to the identification function 134 so that the identification function 134 is established not only for learning data inputted in the past but also for learning data newly inputted. This allows the machine learning executing unit 112 to improve the accuracy of the calculation parameter 133 every time teaming data is inputted to the identification function 134. Accordingly, even when first supplementary information that is not subjected to machine learning is inputted, the priority calculating unit 115 is able to predict and output the priority of the first answer information 131b associated with the inputted first supplementary information with the generalization function of the machine learning, as described later. A specific example of the calculation parameter 133 will be described later.

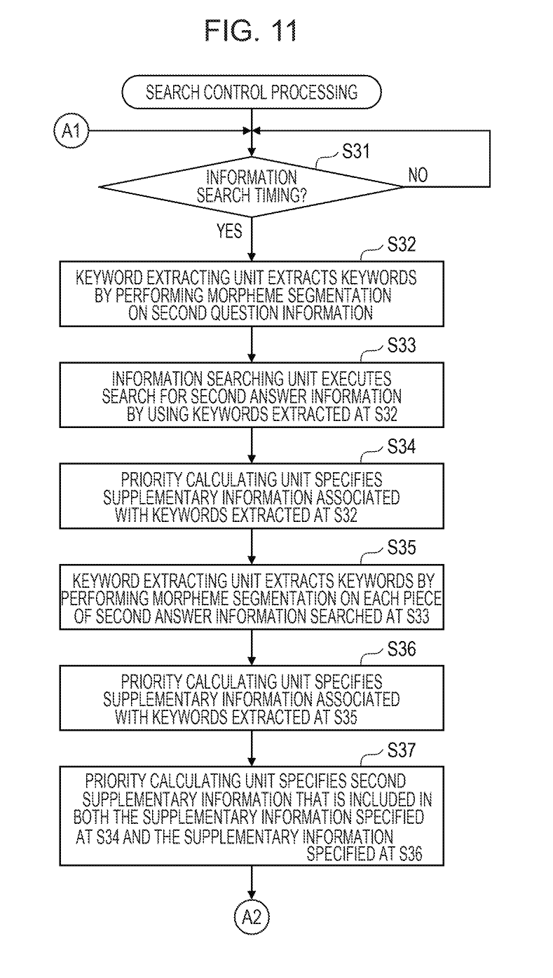

Referring back to FIG. 11, the information receiving unit 113 of the information processing device 1 waits until information search timing (NO at S31). The information search timing is timing when the information receiving unit 113 receives the second question information 141a from the provider terminal 11 (timing when the second question information 141a is inputted), for example. When the information search timing comes (YES at S31), the keyword extracting unit 111 extracts keywords by performing morpheme segmentation on the second question information 141a transmitted from the provider terminal 11 (S32).

Thereafter, the information searching unit 114 of the information processing device 1 executes a search for the second answer information 141b by using keywords extracted in the processing at S32 (S33). Hereinafter, specific examples of the second question information 141a and the second answer information 141b will be described.

[Specific Example of Second Question information Received in Processing at S31]

FIG. 20 is a diagram explaining a specific example of the second question information 141a. The second question information 141a illustrated in FIG. 20 includes, as items, “ITEM NUMBER” that identifies each piece of information included in the second question information 141a, and “QUESTION INFORMATION” to which a content of the second question information 141a is set.

For example, in the second question information 141a illustrated in FIG. 20, “ONE HOUR HAS PASSED FROM END SCHEDULED TIME BUT NETWORK JOB IS NOT ENDED.” is set as “QUESTION INFORMATION” of a piece of information whose “ITEM NUMBER” is “1”.

[Specific Example of Second Answer Information Searched in Processing at S33]

Next, a specific example the second answer information 141b will be described. FIG. 21 is a diagram explaining the specific example of the second answer information 141b. The second answer information 141b illustrated in FIG. 21 includes, as items, “ITEM NUMBER” that identifies each piece of information included in the second answer information 141b, and “ANSWER INFORMATION” to which a content of the second answer information 141b is set.

For example, the second answer information 141b illustrated in FIG. 21 includes three pieces of answer information whose “ITEM NUMBER”s are “1”, “2”, and “3”, respectively. In other words, the second answer information 141b illustrated in FIG. 21 indicates that the three pieces of answer information, as the second answer information 141b, have been searched out as a result of the search by the information searching unit 114 with the second question information 141a.

For example, in the second answer information 141b illustrated in FIG. 21, as “ANSWER INFORMATION” of a piece of information whose “ITEM NUMBER” is “1”, “WHEN ERROR MESSAGE OCCURS, PROCESS IS ABNORMAL. PLEASE STOP PROCESS RUNNING NETWORK JOB.” is set. An explanation of other information included in FIG. 21 is omitted.

Referring back to FIG. 11, the priority calculating unit 115 specifies supplementary information associated with keywords that were extracted in the processing at S32 (S34). Next, the keyword extracting unit 111 extracts keywords by performing morpheme segmentation on each piece of the second answer information 141b that was searched out in the processing at S33 (S35). In addition, the priority calculating unit 115 specifies supplementary information associated with the keywords that were extracted in the processing at S35 (S36). Thereafter, the priority calculating unit 115 specifies second supplementary information that is included in both the supplementary information specified in the processing at S34 and the supplementary information specified in the processing at S36 (S37).

In other words, the keyword extracting unit 111 and the priority calculating unit 115 perform the processing at S32 and from S34 to S37, which is the same as the processing from S22 to S26 explained in FIG. 10. This allows the priority calculating unit 115 to specify the second supplementary information that is information comparable with the first supplementary information included in the calculation parameter 133. Hereinafter, a specific example of second supplementary information associated with one of the multiple pieces of second answer information 141b that were searched out in the processing at S33, will be described.

[Specific Example of Second Supplementary information Specified in Processing at S37]

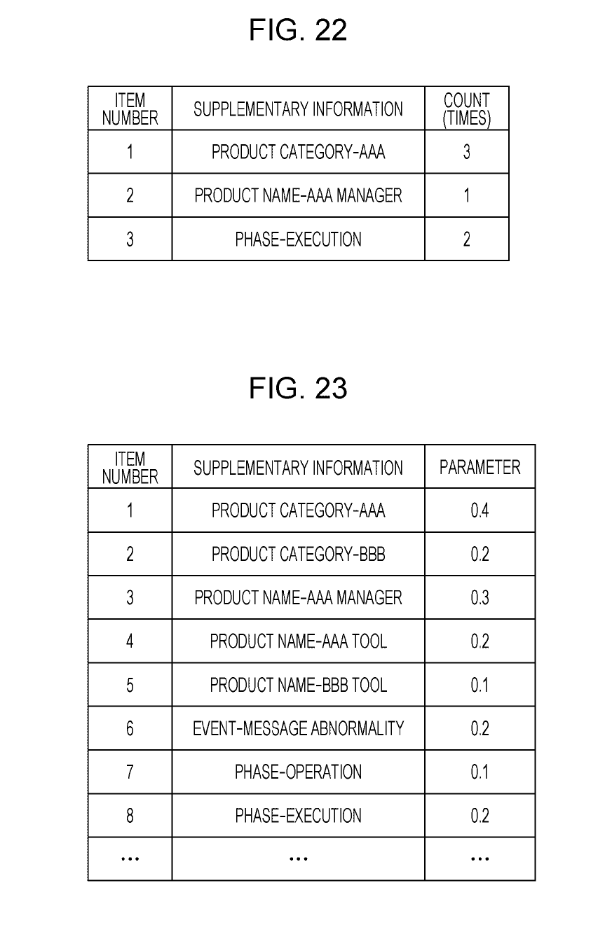

FIG. 22 is a diagram explaining a specific example of second supplementary information specified in the processing at S37. The second supplementary information illustrated in FIG. 22 includes the same items as those in the supplementary information explained in FIG. 16 and the like.

For example, in the second supplementary in illustrated in FIG. 22, for a piece of information whose “ITEM NUMBER” is “1”, “PRODUCT CATEGORY-AAA” is set to “SUPPLEMENTARY INFORMATION”, and “3 (TIMES)” is set to “COUNT”. An explanation of other information included in FIG. 22 is omitted.

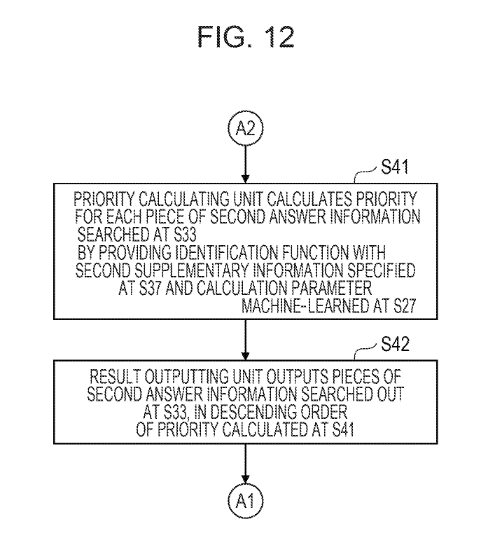

Referring back to FIG. 12, the priority calculating unit 115 calculates the priority for each of the multiple pieces of the second answer information 141b searched out at S33 by providing the identification function 134 with the second supplementary information specified in the processing at S37 and the calculation parameter 133 obtained through the machine learning in the processing at S27 (S41). Hereinafter, a specific example of the calculation parameter 133 and a specific example of priority information will be described.

[Specific Example of Calculation Parameter]

FIG. 23 is a diagram explaining a specific example of the calculation parameter 133. The calculation parameter 133 illustrated in FIG. 23 includes, as items, “ITEM NUMBER” that identifies each piece of information included in the calculation parameter 133, “SUPPLEMENTARY INFORMATION” to which each supplementary information is set, and “PARAMETER” to which a parameter-value is set.

For example, in the calculation parameter 133 illustrated in FIG. 23, for a piece of information whose “ITEM NUMBER” is “1”, “PRODUCT CATEGORY-AAA” is set as “SUPPLEMENTARY INFORMATION”, and parameter-value “0.4” is set as “PARAMETER”. Moreover, in the calculation parameter 133 illustrated in FIG. 23, for a piece of information whose “ITEM NUMBER” is “2”, “PRODUCT CATEGORY-BBB” is set as “SUPPLEMENTARY INFORMATION”, and parameter-value “0.2” is set as “PARAMETER”. An explanation of other information included in FIG. 23 is omitted.

[Specific Example of Priority Information]

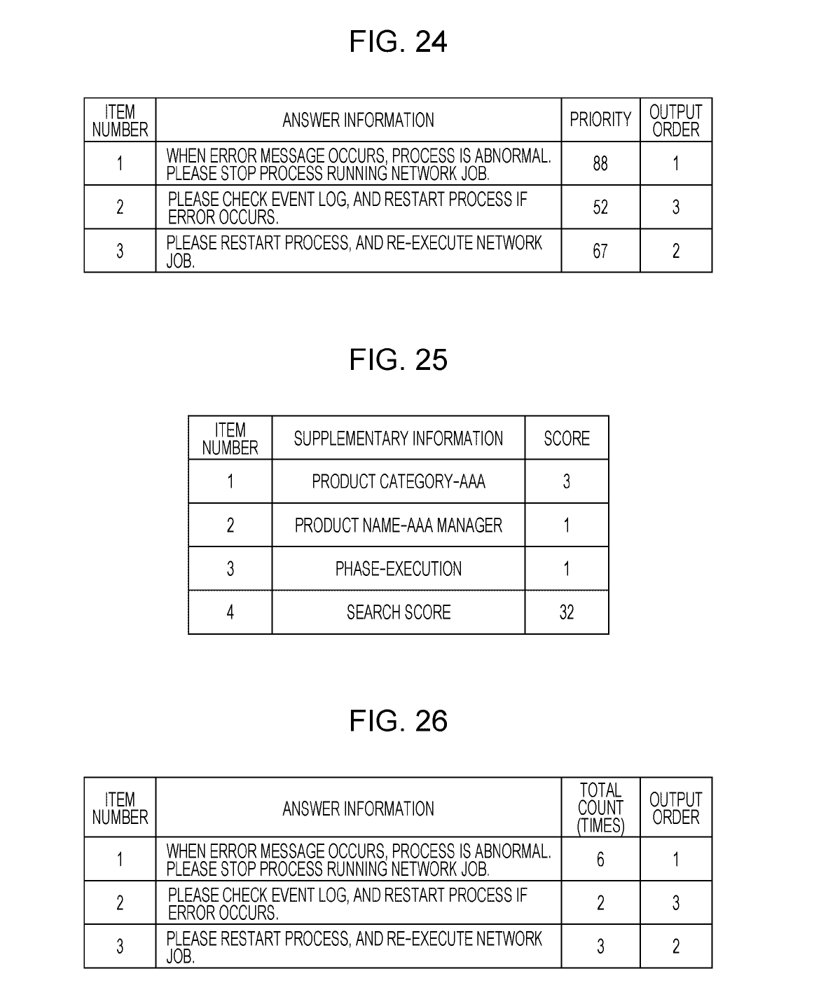

FIG. 24 is a diagram explaining a specific example of priority information. The priority information illustrated in FIG. 24 includes, as items, “ITEM NUMBER” that identifies each piece of information included in the priority information, and “ANSWER INFORMATION” to which the second answer information 141b is set Moreover, the priority information illustrated in FIG. 24 includes, as items, “PRIORITY” to which priority information associated with each piece of second answer information 141b is set, and “OUTPUT ORDER” that indicates the output priority order of the pieces of the second answer information 141b. In the priority information illustrated in FIG. 24, information the same as the information that is set in “ANSWER INFORMATION” of the second answer information 141b explained in FIG. 21 is set to “ANSWER INFORMATION”.

For example, “PRODUCT CATEGORY-AAA”, “PRODUCT NAME-AAA MANAGER”, and “PHASE-EXECUTION” are set to “SUPPLEMENTARY INFORMATION” for the second supplementary information explained in FIG. 22. Accordingly, for example, the priority calculating unit 115 refers to the calculation parameter 133 explained in FIG. 23, and specifies “0.4” that is a parameter-value set to “PARAMETER” for a piece of information whose “SUPPLEMENTARY INFORMATION” is set at “PRODUCT CATEGORY-AAA”. Similarly, the priority calculating unit 115 specifies “0.3” and “0.2” that are parameter-values set to “PARAMETER” for a piece of information whose “SUPPLEMENTARY INFORMATION” is set at “PRODUCT NAME-AAA MANAGER” and for a piece of information whose “SUPPLEMENTARY INFORMATION” is set at “PHASE-EXECUTION”, respectively. The priority calculating unit 115 then respectively multiplies the specified parameter-values “0.4”, “0.3”, and “0.2” by values that are set to “COUNT” and are associated with “PRODUCT CATEGORY-AAA” and others in the second supplementary information explained in FIG. 22, for example. In addition, for example, the priority calculating unit 115 calculates the priority of the second answer information 141b associated with the second supplementary information explained in FIG. 22 by adding the values obtained by the multiplication and multiplying the added value by a predetermined coefficient.

In other words, for example, the priority calculating unit 115 calculates priority so that the priority of the second answer information 141b, whose matching degree between the first supplementary information associated with the right/wrong information 131c indicating a right answer and the second supplementary information is higher than that of different second answer information 141b, becomes higher than the priority of the different second answer information 141b. Meanwhile, for example, the priority calculating unit 115 calculates priority so that the priority of the second answer information 141b, whose matching degree between the first supplementary information associated with the right/wrong information 131c indicating a wrong answer and the second supplementary information is higher than that of different second answer information 141b, becomes lower than the priority of the different second answer information 141b.

The priority calculating unit 115 then determines an output order of the pieces of second answer information 141b in descending, order of values set to “PRIORITY”, for example. Accordingly, as illustrated in FIG. 24, for example, the priority calculating unit 115 sets “88” and “1” respectively to “PRIORITY” and “OUTPUT ORDER” of a piece of information whose “ITEM NUMBER” is “1”. Moreover, for example, the priority calculating unit 115 sets “52” and “3” respectively to “PRIORITY” and “OUTPUT ORDER” of a piece of information whose “ITEM NUMBER” is “2”. In addition, for example, the priority calculating unit 115 sets “67” and “2” respectively to “PRIORITY” and “OUTPUT ORDER” of a piece of information whose “ITEM NUMBER” is “3”.

Referring hack to FIG. 12, the result outputting unit 116 of the, information processing device 1 outputs the multiple pieces of second answer information 141h searched out in the processing at S33, in descending order of the calculated priorities in the processing at S41 (S42). For example, the result outputting unit 116 transmits the priority information explained in FIG. 24 and the multiple pieces of second answer information 141b, to the provider terminal 11. The provider terminal 11 then outputs the multiple pieces of second answer information 141b to the output device (output device viewable by the user) in ascending order of information set to “OUTPUT ORDER” of the transmitted priority information, for example,

This allows the information processing device 1 to preferentially output a piece of second answer information 141b that the user is highly likely to seek for. Accordingly, the information processing device 1 allows the user to preferentially read the piece of second answer information 141b that the user is highly likely to seek for.

Further, in the processing at S26, the machine learning executing unit 112 may specify first supplementary information by considering information other than the supplementary information specified at S24 and the supplementary information specified S25.

In this case, for example, the machine learning executing unit 112 causes the information searching unit 114 to execute a search for the first answer information 131b with keywords extracted from the first question information 131a. The machine learning executing unit 112 acquires, for each piece of first answer information 131b that is searched out with the keywords extracted from the first question information 131a, information (hereinafter, also referred to as search score) indicating the, priority of the output calculated by the information searching unit 114, for example. Thereafter, for example, the machine learning executing unit 112 sets the acquired search score as a part of first supplementary information. Hereinafter, a specific example of the first supplementary information to search be described.

[Specific Example of First Supplementary Information to Which Search Score is Set]

FIG. 25 is a diagram explaining a specific example of first supplementary information to which a search score is set. The first supplementary information illustrated in FIG. 25 includes, as an item, “SCORE” to which the number of times or a search score is set, instead of “COUNT” that is the item of the first supplementary information explained in FIG. 19. For example, in the first supplementary information illustrated in FIG. 25, for a piece of information whose “ITEM NUMBER” is “4”, “SEARCH SCORE” is set as “SUPPLEMENTARY INFORMATION”, and “32” is set as “COUNT”.

In this case, the priority calculating unit 115 acquires a search score of each piece of second answer information 141b that is searched out when the processing at S33 is executed. Moreover, the priority calculating unit 115 sets the acquired search score as a part of the second supplementary information. This allows the priority calculating unit 115 to determine the output priority of the second answer information 141 with higher accuracy in the processing at S41.

In this manner, the information processing device 1 in this embodiment extracts keywords from the first question information 131a and the first answer information 131b, which are included in the teacher data 131. The information processing device 1 then executes machine learning on the calculation parameter 133 for calculating the predicted-reliability of the first answer information 131b indicating how much the first answer information 131b is likely to be an answer that is responsive to the first question information 131a. For example, the information processing device 1 executes machine learning, based on supplementary information associated with keywords extracted from the first question information 131a, supplementary information associated with keywords extracted from the first answer information 131b, and the right/wrong information 131c indicating whether the first answer information 131b is a right answer to the first question information 131a.

Thereafter, when the information processing device 1 outputs multiple pieces of the second answer information 141b associated with the inputted second question information 141a, the information processing device 1 calculates the predicted reliabilities of the multiple pieces of the second answer information 141b. For example, the information processing device 1 calculates the predicted-reliability of each of the multiple pieces of second answer information 141b, with the calculation parameter 133 obtained through the machine learning, based on supplementary information associated with keywords extracted from the second question information 141a and supplementary information associated with the keywords extracted from the each piece of second answer information 141b.

This allows the information processing device 1 to preferentially output a piece of second answer information 141b that the user seeks for. Accordingly, the information processing device 1 allows the user to preferentially read the piece of second answer information 141b that the user seeks for.

### Second Embodiment

Next, a second embodiment will be described. FIG. 26, is a diagram explaining search control processing in the second embodiment.

The information processing device 1 in the first embodiment executes machine learning on the calculation parameter 133, and refers to the calculation parameter 133 obtained through the machine learning to determine the output priority of the second answer information 141b.

In contrast, the information processing device 1 in the second embodiment does not perform processing of executing the machine learning on the calculation parameter 133 (the processing from S21 to S27 explained in FIG. 10). Meanwhile, the information processing device 1 in the second embodiment performs the processing from S31 to S37 explained in FIG. 11, and creates the second supplementary information explained in FIG. 22 for each piece of second answer information 141b. Thereafter, the information processing device 1 in the second embodiment calculates the total sum (hereinafter, also referred to as a total count) of values set to “COUNT” for the second supplementary information explained in FIG. 22 for each piece of second answer information 141b in the processing at S41 and S42, and outputs the pieces of the second answer information 141b in descending order of the calculated total count. Hereinafter, priority information in the second embodiment will be described.

### Specific Example of Priority Information in Second Embodiment

FIG. 26 is a diagram explaining a specific example of priority information in the second embodiment. The priority information illustrated in FIG. 26 includes, as an item, “TOTAL COUNT” to which the total count is set, instead of “PRIORITY” that is an item included in the priority information explained in FIG. 24.

For example, in the priority information illustrated in FIG. 26, for a piece of information whose “ITEM NUMBER” is “1”, “6 (TIMES)” is set as “TOTAL COUNT”, and “1” is set as “OUTPUT ORDER”. Moreover, in the priority information illustrated in FIG. 26, for a piece of information whose “ITEM NUMBER” is “2”, “2 (TIMES)” is set as “TOTAL COUNT”, and “3” is set as “OUTPUT ORDER”. In addition, in the priority information illustrated in FIG. 26, for a piece of information whose “ITEM NUMBER” is “3”, “3 (TIMES)” is set as “TOTAL COUNT”, and “2” is set as “OUTPUT ORDER”. In other words, in the priority information illustrated in FIG. 26, information set to “OUTPUT ORDER.” indicates the order of the magnitudes of values set to “TOTAL COUNT”.

With this, the information processing device 1 in the second embodiment does not have to execute machine learning on the calculation parameter 133. Moreover, the information processing device 1 in the second embodiment does not have to perform the input and the like to the identification function 134 when the total count is decided, so that the information processing device 1 is able to easily determine output order of the second answer information 141b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process comprising:
providing teacher data including first question information and first answer information, each piece of the first question information indicating a question about a predetermined subject, each piece of the first answer information being associated with a piece of the first question information and indicating an answer that is responsive to the piece of the first question information;
providing supplementary information each piece of winch is associated with one or more keywords that are used within the question information or the answer information in connection with the each piece of supplementary information;
extracting first keywords from the first question information and the first answer information;
adjusting a calculation parameter including parameter-values that are each associated with one of pieces of the supplementary information and used for calculating a predicted-reliability, based On the supplementary information associated with the first keywords, and right/wrong information indicating whether each piece of the that answer information is a right answer to a piece of the first question information associated with the each piece of the first answer information, the predicted-reliability indicating a likelihood that each piece of the first answer information is an answer that is responsive to a piece of the first question information associated with'the each piece of the first answer information; and
when outputting plural pieces of second answer information in response to new question information, calculating the predicted-reliability of each piece of the second answer information, based on the adjusted calculation parameter, by using the supplementary information associated with second keywords that are extracted from the new question information and the each piece of the second answer information.

2. The non-transitory computer-readable recording medium of claim 1, wherein
each piece of the supplementary information is information identifying a group of keywords having meanings falling under a same concept.

3. The non-transitory computer-readable recording medium of claim 1, wherein
the adjusting the calculation parameter is performed by using the right/wrong information and first supplementary information that is included in both the supplementary information associated with keywords extracted from the first question information and the supplementary information associated with keywords extracted from the first answer information.

4. The non-transitory computer-readable recording medium of claim 3, wherein
the calculating the predicted-reliability includes:
identifying, for each of the plural pieces of the second answer information, second supplementary information that includes both the supplementary information associated with keywords extracted from the new question information and the supplementary information associated with keywords extracted from the each piece of the second answer information, and
adjusting the calculation parameter so that the predicted-reliability of a piece of the second answer information, whose matching degree between the first supplementary information associated with the right/wrong information indicating a right answer and the second supplementary information is higher than the matching degree of a different piece of the answer information, is higher than the predicted-reliability of the different piece of the second answer information.

5. The non-transitory computer-readable recording medium of claim 3, wherein
the calculating the predicted-reliability includes:
identifying, for each of the plural pieces of the second answer information, second supplementary information that includes both the supplementary information associated with keywords extracted from the new question information and the supplementary information associated with keywords extracted from the each piece of the answer information, and
adjusting the calculation parameter so that the predicted-reliability of a piece of the second answer in whose matching degree between the first supplementary information associated with the right/wrong information indicating a wrong answer and the second supplementary information is higher than the matching degree of a different piece of the second answer information, is lower than the predicted-reliability of the different piece of the second answer information.

6. The non-transitory computer-readable recording medium of claim 4, wherein
the first supplementary information further includes information indicating priority with which the first answer information has been outputted in a case of searching for answer information with keywords extracted from the first question information; and
the second supplementary information further includes information indicating priority with which each piece of the second answer information has been outputted among the plural pieces of the answer information in a case of searching for answer information with keywords extracted from the new question information.

7. The non-transitory computer-readable recording medium of claim 1, wherein
the process further includes outputting the plural pieces of the second answer information in descending order of the calculated predicted-reliability.

8. A non-transitory computer-readable recording medium having stored therein a program for causing a computer to execute a process comprising:
receiving teacher data including first question information, first answer information, and right/wrong information indicating whether the first answer information is aright answer to the first question information;
identifying first supplementary information within supplementary information each piece of which is associated with one or more keywords that are used within the first question information or the first answer information in connection with the each piece of the supplementary information, the first supplementary information being associated with first keywords extracted from the received question information, and adjusting, based on the right/wrong information, a calculation parameter including parameter-values that are each associated with one of pieces of the supplementary information and used for calculating a predicted-reliability indicating a likelihood that the first answer information including second keywords associated with the identified first supplementary information is an answer that is responsive to the received first question information; and
when presenting plural pieces of second answer information to be extracted in response to newly inputted second question information, evaluating the predicted-reliability of each of the plural pieces of the second answer information, based on the adjusted calculation parameter and second supplementary information within the supplementary information, the second supplementary information being associated with third keywords extracted from the each piece of the second answer information.

9. An apparatus comprising:
a memory configured to store teacher data and supplementary information, the teacher data including first question information and first answer information, each piece of the first question information indicating a question about a predetermined subject, each piece of the first answer information being associated with a piece of the first question information and indicating an answer that is responsive to the piece of the first question information, each piece of the supplementary information being associated with one or more keywords that are used within the first question information or the first answer information in connection with the each piece of supplementary information; and
a processor coupled to the memory and configured to:
extract first keywords from the first question information and the first answer information,
adjust a calculation parameter including parameter-values that are each associated with one of pieces of the supplementary information and used for calculating a predicted-reliability, based on the supplementary information associated with the first keywords, and right/wrong information indicating whether each piece of the first answer information is a right answer to a piece of the first question information associated with the, each piece of the first answer information, the predicted-reliability indicating a likelihood that each piece of the first answer information is an answer that is responsive to apiece of the first question information associated with the each piece of the first answer information, and
when outputting plural pieces of second answer information in response to new question information, calculate the predicted-reliability of each piece of the second, answer information, based on the adjusted calculation parameter, by using the supplementary information associated with second keywords that are extracted from the new question information and, the each piece of the second answer information.

10. An apparatus comprising:
a processor configured to:
receive teacher data including first question information, first answer information, and right/wrong information indicating whether the first answer information is a right answer to the first question information,
identify first supplementary information within supplementary information each piece of which is associated with one or more keywords that are used within the first question information or the first answer information in connection with the each piece of the supplementary information, the first supplementary information being associated with first keywords extracted from the received question information, and adjust, based on the right/wrong information, a calculation parameter including parameter-values that are each associated with one of pieces of the supplementary information and used for calculating predicted-reliability indicating a likelihood that the first answer information including second keywords associated with the identified first supplementary information is an answer that is responsive to the received first question information, and
when presenting plural pieces of second answer information to be searched for in response to newly inputted second question information, evaluate the predicted-reliability of each of the plural pieces of the second answer information, based on the adjusted calculation parameter and second supplementary information within the supplementary information that is associated with third keywords extracted from the each piece of the second answer information; and
a memory coupled to the processor and configured to stole the teacher data and the supplementary information.

11. A method comprising;
providing teacher data including first question information and first answer information, each piece of the first question information indicating a question about a predetermined subject each piece of the first answer information being associated with a piece of the first question information and indicating an answer that is responsive to the, piece of the first question information;
providing supplementary information each piece of which is associated with one or more keywords that are used within the question information or the answer information in connection with the each piece of supplementary information;
extracting first keywords from the first question information and the first answer information;
adjusting a calculation parameter including parameter-values that are each associated with one of pieces of the supplementary information and used tar calculating a predicted-reliability, based on the supplementary information associated with the first keywords, and right/wrong information indicating whether each piece of the first answer information is a right answer to a piece of the first question information associated with the each piece of the first answer information, the predicted-reliability indicating a likelihood that each piece of the first answer information is an answer that is responsive to a piece of the first question information associated with the each piece of the first answer information; and
when outputting plural pieces of second answer information in response to new question information, calculating the predicted-reliability of each piece of the second answer information, based on the adjusted calculation parameter, by using the supplementary information associated with second keywords that are extracted float the new question information and the each piece of the second answer information.

12. A method comprising:
receiving teacher data including first question information, first answer information, and right/wrong information indicating whether the first answer information is a right answer to the first question information;
identifying first supplementary information within supplementary information each piece of which is associated with one or more keywords that are used within the first question information or the first answer information in connection with the each piece of the supplementary information, the first supplementary information being associated with first keywords extracted from the received question information, and adjusting, based on the right/wrong information, a calculation parameter including parameter-values that are each associated with one of pieces of the supplementary information and used for calculating a predicted-reliability indicating a likelihood that the first answer information including second keywords associated with the identified first supplementary information is an answer that is responsive to the received first question information; and
when presenting plural pieces of second answer information to be extracted in response to newly inputted second question information, evaluating the predicted-reliability of each of the plural pieces of the second answer information, based on the adjusted calculation parameter and second supplementary information within the supplementary information, the second supplementary information being associated with third keywords extracted from the each piece of the second answer information.
